(19) United States
(12) Patent Application Publication
(10) Pub. No.: US 2015/0008172 A1
(43) Pub. Date: Jan. 8, 2015

(54) Filter Element and Filter Device

(71) Applicant: MANN+HUMMEL GMBH, Ludwigsburg (DE)

(72) Inventor: Christian Kocksch, Roemerberg (DE)

(21) Appl. No.: 14/493,851

(22) Filed: Sep. 23, 2014

Related U.S. Application Data
(63) Continuation of application No. PCT/EP2013/052409, filed on Feb. 7, 2013.

(30) Foreign Application Priority Data
Mar. 23, 2012 (DE) 10 2012 005 733.4

(51) Int. Cl. B01D 29/15; B01D 35/18

(52) U.S. Cl. CPC B01D 29/15; B01D 35/18
USPC 210/184; 210/497.01; 210/437

(57) ABSTRACT

A filter element for filtering a urea-water solution has a filter medium having an internal space. A supporting body is disposed in the internal space and has a hollow space which protrudes into the internal space. The hollow space is closed relative to a filtered side of the filter element and is open relative to an unfiltered side of the filter element. A compensation element is arranged in the hollow space.

### CROSS-REFERENCE TO RELATED APPLICATIONS

This application is a continuation application of international application No. PCT/EP2013/052409 having an international filing date of 7 Feb. 2013 and designating the United States, the international application claiming a priority date of 23 Mar. 2012, based on prior filed German patent application No. 10 2012 005 733.4, the entire contents of the aforesaid international application and the aforesaid German patent application being incorporated herein by reference.

### BACKGROUND OF THE INVENTION

The invention relates to a filter element for filtering a fluid, in particular a urea-water solution. Furthermore, the invention relates to a filter device.

By way of example, urea-water solutions are used in the treatment of exhaust gas in motor vehicles in order to reduce nitrogen oxide emissions. In doing so, urea-water solution is injected by means of nozzles in the exhaust train. The urea-water solution must be filtered, particularly to prevent blocking of the nozzles.

By way of example, WO 2010/139706 A1 describes a filter element for filtering urea-water solutions. As such urea-water solutions freeze at approximately −11° C., the disclosed filter element provides a compensation element made of elastically deformable material. When the urea-water solution freezes, the compensation element absorbs an increasing volume of liquid.

Further, a filter element having a supporting element with a separating wall which borders a dead volume, is disclosed in DE 10 2004 025 811 A1.

### SUMMARY OF THE INVENTION

An object of the present invention is to provide an improved filter element and an improved filter device.

To achieve this object, a filter element for filtering a fluid, in particular a urea-water solution, which has a filter medium and a supporting body, is proposed. The filter medium encompasses an internal space and the supporting body a hollow space which protrudes into the internal space. The hollow space is closed relative to the filtered side of the filter element and is open relative to an unfiltered side of the filter element.

As the hollow space protrudes into the internal space, the fluid volume on the filtered side is reduced. As a consequence of this, a compensation element, which absorbs an increasing volume of liquid when the fluid, for example the urea-water solution described above, freezes, can be made smaller. The dimensions of a filter device which includes such a filter element are therefore also reduced. In addition, the hollow space formed can be used to accommodate other elements of the filter element, for example, a compensation element. As a result, the dimensions of the filter element and of a corresponding filter device with the filter element are further reduced. As, in accordance with the invention, the frozen quantity of fluid on the filtered side is reduced, it can also thaw more quickly, and the heating power of a heating element provided for the melting process can be reduced. In addition, a compensation element on the filtered side can be dispensed with due to the reduced quantity of fluid on the filtered side. Herein lies an advantage compared with the device disclosed in WO 2010/139706 A1, as such compensation elements arranged particularly on the filtered side are subject to higher component cleanliness and stability requirements, which can have an effect on the manufacturing costs. This is so because particles adhering to the compensation element may detach from the compensation element while the filter element is in use and can damage the nozzles mentioned above, for example. Nevertheless, in connection with the presently disclosed invention, it would also be conceivable to provide a small compensation element, for example, on the filtered side.

The fluid is typically a liquid, in particular a urea-water solution. Preferably, the filtered side of the filter element is an internal space surrounded by the filter medium. Accordingly, the unfiltered side, to which, for example, a fluid to be cleaned can flow, is arranged on the opposite side and therefore on the outside of the filter medium. Of course, the flow can also take place in the opposite direction, thus resulting in a reverse arrangement of filtered side and unfiltered side.

According to an embodiment, a compensation element is arranged in the hollow space. The compensation element preferably comprises an elastomer. Furthermore, the compensation element can have closed pores and/or be foamed. The pores can be filled with air. Preferably, the compensation element comprises an ethylene propylene diene monomer (also referred to as “EPDM”). The compensation element can partially or completely fill the hollow space. As the compensation element is arranged in the hollow space, the dimensions of the filter element and the filter device are smaller.

According to a further embodiment, the compensation element is mushroom-shaped with a stalk section, which is arranged in the hollow space, and a head section which rests against an end disk of the filter element. As a result, a large volume of the compensation element is achieved, which at the same time can be accommodated in a space-saving manner.

According to a further embodiment, the section of the supporting body which encompasses the hollow space forms a cup-shaped geometry together with the end disk. Such a geometry can be easily produced, for example, by injection molding.

According to a further embodiment, the filter element has an end disk which is formed in one piece (monolithic) with the supporting body. This measure also guarantees that the supporting body complete with the end disk can be easily produced, for example, by injection molding. The design of the supporting tube in one piece with the end disk leads to a reduction in the number of components, which in turn improves the ability to manufacture the filter element.

According to a further embodiment, a channel, which is in fluid communication with the unfiltered side, is formed between the compensation element and the supporting body and/or between the compensation element and an end disk of the filter element. The channel has the advantage that pressure peaks are avoided and a uniform compression of the compensation element is guaranteed. The channel can be formed, for example, by one or more grooves in the compensation element, in the supporting body and/or in the end disk. Furthermore, the channel can be created, for example, by a flat portion of the cross-section of the compensation element which, for example, is circular in cross section, when the cross-section with the flat portion engages the hollow space which, for example, is formed with a circular cross section. Likewise, the channel can be created by elevations on the surface of the compensation element which keep a wall, which borders the hollow space of the supporting body, at a distance from the surface of the compensation element. Furthermore, it is conceivable to provide the compensation element with smaller dimensions, in particular with a smaller diameter, than the hollow space, thus producing a channel between the compensation element and the wall which borders the hollow space.

According to a further embodiment, the supporting body has a first section which encompasses the hollow space and a second section which includes discharge openings for discharge of filtered fluid from an intermediate space formed between the supporting tube and the filter medium to a connecting opening of the filter element. Although the filtered fluid in the intermediate space in the region of the first section of the supporting body “sees” a closed surface, the filtered fluid in the region of the second section can be discharged through the discharge openings in the supporting body to the connecting opening of the filter element and therefore out of said filter element.

According to a further embodiment, ribs, which in particular serve as spacers between the filter medium and the supporting body, are formed on the outside of the supporting body in the region of the first and/or second section. The ribs preferably extend up to the filter medium. However, apertures can be provided between the ribs in order to guarantee that the filtered fluid flows in a direction perpendicular to the extension plane of the ribs.

According to a further embodiment, the supporting body is in the form of a central tube which comprises the first and second sections, wherein the discharge openings comprise an axial discharge opening and a radial discharge opening in the second section of the central tube. The fluid to be filtered therefore initially flows radially inwards out of the intermediate space into the central tube and is then conveyed axially out of the central tube at its end face to the connecting opening of the filter element.

According to a further embodiment, the filter element has first and second end disks, between which the supporting body extends, wherein the first section thereof is connected to the first end disk and the second section thereof borders the second end disk. In this way, a long supporting body, which imparts high stability to the filter element, is created. According to an embodiment, the supporting body can also be supported on the second end disk, that is to say be in contact therewith, by means of its second section.

According to a further embodiment, the filter element has a rod heating element which extends into the second section of the filter element. Advantageously, in a filter device, the rod heating element is permanently or releasably arranged on or fixed to a housing. This enables a frozen fluid to be quickly thawed. In addition, the rod heating element further reduces the fluid volume on the filtered side. This, in turn, has the effect that the compensation element can be provided with even smaller dimensions.

Furthermore, a filter device with the filter element according to the invention is proposed.

The filter device can have a housing in which the filter element is accommodated. Furthermore, the filter device can include connectors, by means of which fluid to be filtered can be fed to the filter element and filtered fluid can be discharged therefrom.

The filter device can be part of a motor vehicle, for example.

Further possible implementations of the invention also include not explicitly mentioned combinations of characteristics or embodiments of the filter element or of the filter device which are described above or in the following with regard to the exemplary embodiments. A person skilled in the art will therefore also add or modify individual aspects as improvements or additions to the respective basic form of the invention.

Further embodiments of the invention are the subject matter of the dependent claims and of the exemplary embodiments of the invention described below. The invention is explained in more detail below based on exemplary embodiments with reference to the attached figures.

### BRIEF DESCRIPTION OF THE DRAWINGS

FIG. 1 shows a filter element according to an embodiment in an exploded view.

FIG. 2 shows the filter element of FIG. 1 fitted in a filter device in a side view.

FIG. 3 shows a variant compared with the embodiment according to FIG. 2.

In the figures, the same reference numbers designate the same, or functionally the same, elements unless stated otherwise.

### DESCRIPTION OF PREFERRED EMBODIMENTS

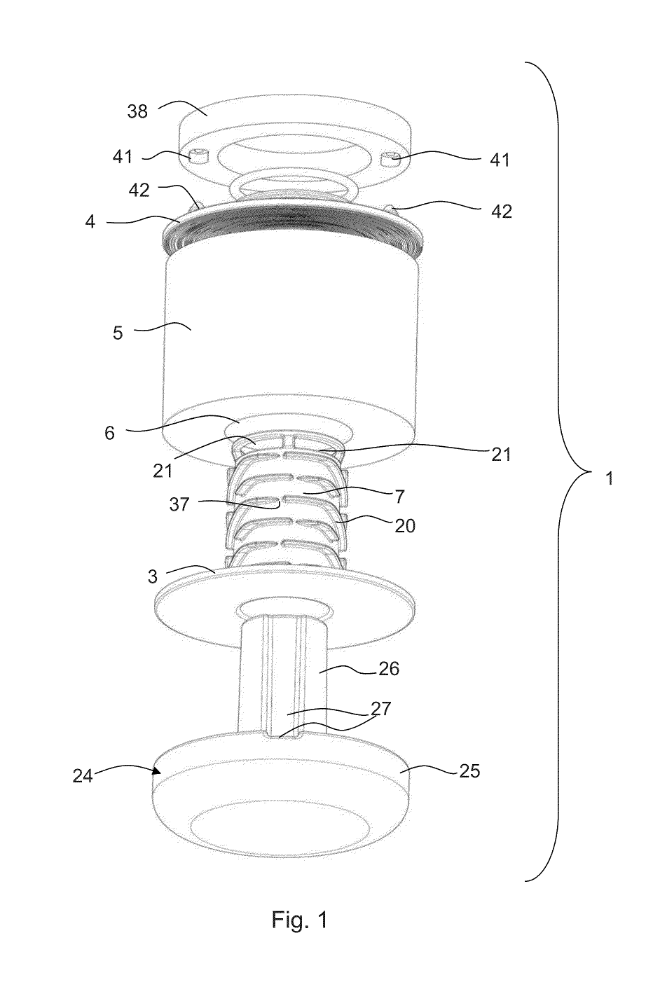

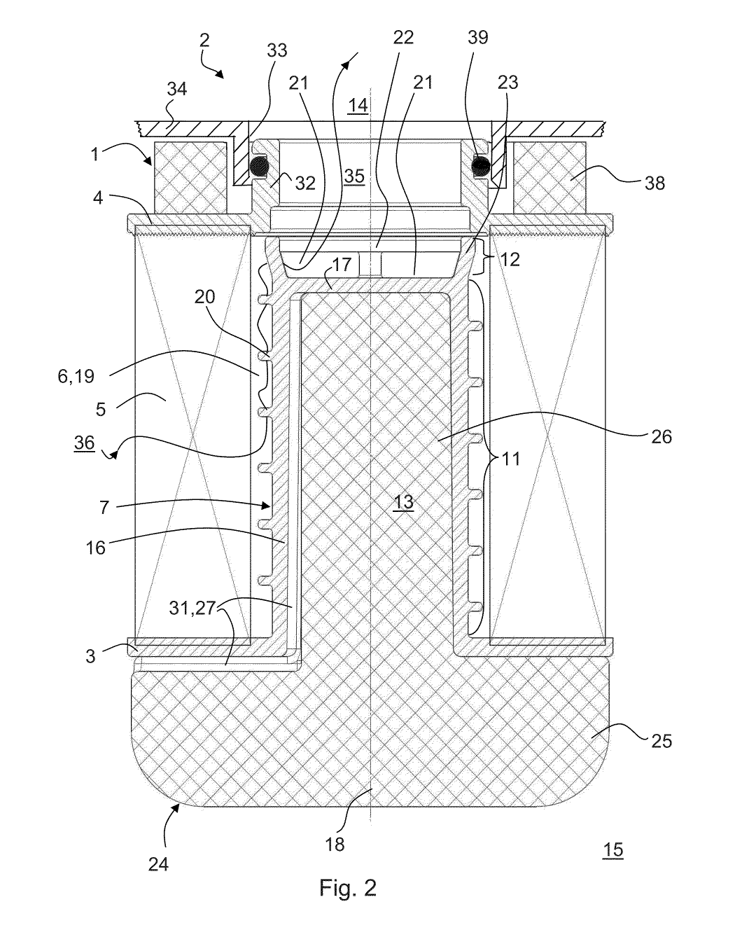

FIG. 1 shows a filter element 1 according to an embodiment in an exploded view. FIG. 2 shows the filter element 1 of FIG. 1 in a state where it is fitted in a filter device 2 in a side view. The filter device 2 can be provided in a motor vehicle, for example. The filter device 2 can be set up to clean a liquid, in particular a urea-water solution. By way of example, the urea-water solution is a 25% to 35% urea-water solution. Urea-water solutions of 30% to 35%, in particular 32.5%, are common. The percentages here relate to percent by volume.

Returning to FIG. 1, here it is shown that the filter element 1 includes a first end disk 3 and a second end disk 4. A filter medium in the form of a bellows 5 is arranged between the two end disks 3, 4. The bellows 5 has an annular cross section and is welded in a liquid-tight manner to the end disks 3, 4 at its opposite ends. As shown in FIG. 2, a supporting body in the form of a central tube 7 is arranged in the internal space 6 enclosed by the bellows 5. The central tube 7 comprises first and second sections 11, 12.

The first section 11 has a hollow space 13 which is closed relative to a filtered side 14 of the filter element 1 and open relative to an unfiltered side 15 of the filter element 1. The hollow space 13 is bordered radially by a wall 16 of the central tube 7 and axially on one side by a web 17 which closes the internal cross section of the central tube 7. Here “radially” and “axially” relate to a central axis 18 (see FIG. 2) of the filter element 1. At its open end, the first section 11 of the central tube 7 is connected in one piece (monolithic) to the first end disk 3. For this purpose, the central tube 7 together with the end disk 3 can be produced in one step by injection molding. The end disk 3 is preferably annular in shape and, together with the wall 16 and the web 17 of the first section 11, forms a cup-shaped geometry.

The second section 12 of the central tube is provided with radial discharge openings 21 and, on the face side, with an axial discharge opening 22. The end 23 of the second section 12 which has the axial discharge opening 22 borders the second end disk 4. In doing so, the end 23 can rest directly against the end disk 4 or have a small gap relative to the end disk 4. The latter is shown in FIG. 2. Ribs 20, which extend radially outwards into an annular intermediate space 19 between the central tube 7 and the filter medium 5, are formed on the second section 12 of the central tube 7. The ribs 20 stiffen the central tube 7.

Furthermore, the filter element 1 has a mushroom-shaped compensation element 24 made of EPDM, which comprises a head section 25 and a stalk section 26. As can be seen in FIG. 1, a groove 27 is formed in the head section 25 and the stalk section 26. As can be seen in FIG. 2, the groove 27 extends inwards in radial direction on the side of the head section 25 which faces the first end disk 3 and from there runs further in axial direction along the outside of the stalk section 26. In conjunction with the end disk 3 and the central tube 7, the groove 27 therefore forms a channel 31. The channel 31 is connected in a liquid-conducting manner to the unfiltered side 15.

An axial collar 32 extends from the second end disk 4 into a connecting opening 33 of a housing 34 of the filter device 2 and seals relative to it on the outside, for example by means of an O-ring 39. The filter element 1 is releasably fixed in the connecting opening 33 and can be replaced as required. The collar 32 has a connecting opening 35 of the filter element 1 which is connected in a liquid-conducting manner to the connecting opening 33 of the filter device 2 and to the discharge opening 22 of the central tube 7.

When the filter device 2 is in use, liquid 36 to be cleaned, which flows through the filter medium 5 and is filtered thereby, is present at the unfiltered side 15 of the filter element 1. The movement of the liquid 36 through the filter device 2 is indicated in FIG. 2 by an appropriate path. The liquid 36 therefore passes into the intermediate space 19 and from there flows in axial direction through apertures 37 (see FIG. 1) between the ribs 20. Finally, the liquid 36 passes through the radial discharge openings 21 in the second section 12 of the central tube 7 and subsequently through the axial discharge opening 22 thereof to the connecting opening 35 from where it is discharged from the filter device 2.

If the filter device 2 is now exposed to very cold conditions, for example, in winter, then the liquid 36 can freeze, particularly in the intermediate space 19. However, as the intermediate space 19 is only small, the liquid volume which can potentially freeze is likewise only small. The change in volume associated with freezing can be absorbed by the compensation element 24. Additionally, the filter element 1 can have a further compensation element 38 which is arranged between the second end disk 4 and the housing 34. According to the exemplary embodiment, the compensation element 38 is annular in shape and surrounds the collar 32. The compensation element 38 can have recesses shown in FIG. 1, in which a pin 42 formed on the second end disk 4 engages, respectively, in order to fix the compensation element 38 with respect to the second end disk 4.

In addition, in the event of freezing, the pressure between the hollow space 13 and the intermediate space 19 can be balanced by means of the channel 31, so that pressure peaks acting on the wall 16 are avoided and an equalization of the compression of the compensation element 24 is achieved.

According to a further embodiment, no ribs 20 are provided. Instead, the central tube 7 is formed with a larger diameter compared with FIG. 2 so that the intermediate space 19 is small in order to further reduce the liquid volume on the filtered side 14 within the bellows 5.

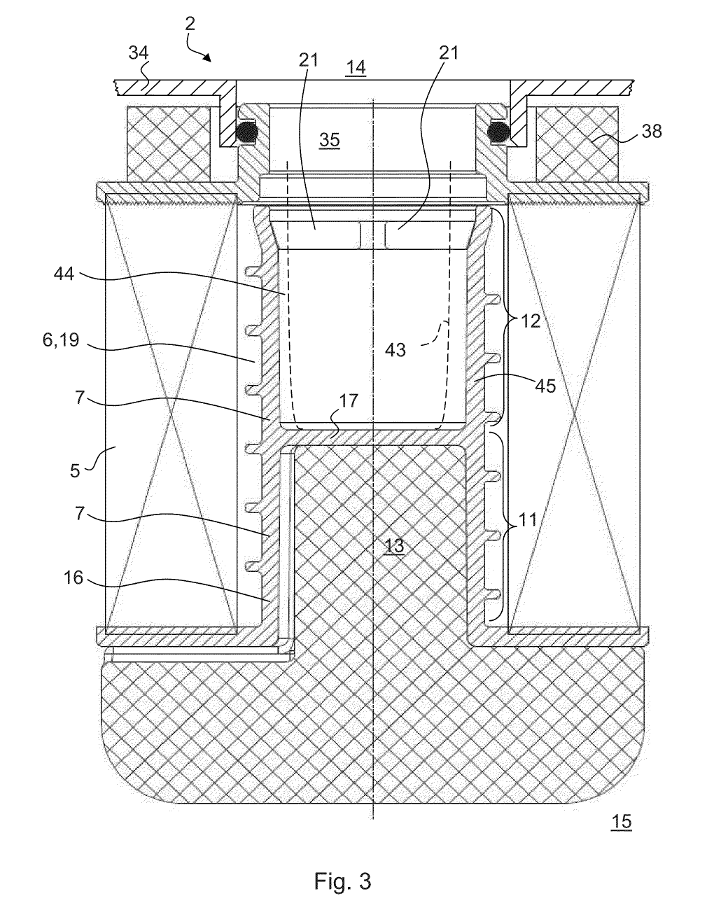

In contrast to FIG. 2, FIG. 3 shows a filter element 1 where the first and second sections 11, 12 of the central tube 7 are approximately of the same length. A rod heating element 43 (shown in dashed lines) is arranged in a hollow space 44 of the second section 12 of the central tube 7. The hollow space 44 is bordered by a wall 45 of the central tube 7 and by the web 17. The hollow space 44 is connected in a liquid-conducting manner to the intermediate space 19 by means of the radial discharge openings 21. The liquid 36 or corresponding ice can be quickly heated or thawed respectively by means of the rod heating element 43.

While specific embodiments of the invention have been shown and described in detail to illustrate the inventive principles, it will be understood that the invention may be embodied otherwise without departing from such principles.

What is claimed is:

1. A filter element for filtering a urea-water solution, the filter element comprising:
a filter medium having an internal space;
a supporting body disposed in the internal space and comprising a hollow space which protrudes into the internal space, wherein the hollow space is closed relative to a filtered side of the filter element and is open relative to an unfiltered side of the filter element;
a compensation element arranged in the hollow space.

2. The filter element as claimed in claim 1, further comprising a first end disk disposed on a first end of the filter medium.

3. The filter element as claimed in claim 2, wherein the compensation element has a mushroom shape comprised of a stalk section and a head section connected to the stalk section, wherein the stalk section is arranged in the hollow space and wherein the head section rests against the first end disk.

4. A filter element as claimed in claim 2, wherein the first end disk is monolithic with the supporting body.

5. A filter element as claimed in claim 2, wherein a channel is formed between the compensation element and the supporting body and between the compensation element and the first end disk.

6. A filter element as claimed in claim 1, wherein an intermediate space is formed between the supporting body and the filter medium, wherein the supporting body has a first section and a second section, wherein the hollow space is provided in the first section and wherein the second section comprises discharge openings through which a filtered fluid is discharged from the intermediate space to a connecting opening of the filter element.

7. The filter element as claimed in claim 6, wherein the supporting body is a central tube comprising the first and second sections, wherein the discharge openings are provided in the second section and include an axial discharge opening and a radial discharge opening.

8. A filter element as claimed in claim 6, further comprising a first end disk and a second end disk disposed on opposed ends of the filter medium, wherein the supporting body extends between the first and second end disks, wherein the first section is connected to the first end disk and the second section borders the second end disk.

9. A filter element as claimed in claim 6, further comprising a rod heating element which extends into the second section.

10. A filter device comprising a housing and a filter element as claimed in claim 1 arranged in the housing.
